(19) United States
(12) Patent Application Publication
(10) Pub. No.: US 2016/0299713 A1
(43) Pub. Date: Oct. 13, 2016

(54) DATA AGGREGATOR SERVING BETWEEN DATA SOURCE AND ELECTRONIC DEVICE AND ASSOCIATED DATA MANAGEMENT METHOD

(71) Applicant: MEDIATEK INC., Hsin-Chu (TW)

(72) Inventors: Chi-Hsuan Lin, New Taipei City (TW); Chih-Hsiang Hsiao, Taipei City (TW); Po-Yu Chen, Hsinchu City (TW); Chi-Chang Lai, Hsinchu County (TW)

(21) Appl. No.: 14/883,640

(22) Filed: Oct. 15, 2015

Related U.S. Application Data
(60) Provisional application No. 62/146,420, filed on Apr. 13, 2015.

(51) Int. Cl. G06F 3/06

(52) U.S. Cl. CPC G06F 3/0619; G06F 3/065; G06F 3/068; G06F 3/0656

(57) ABSTRACT

The present invention provides a data aggregator serving between at least one data source and at least one electronic device, wherein the data aggregator is arranged to wirelessly communicate with the data source and the electronic device, and the data aggregator comprises a memory comprising a data cache, a backup memory and a FIFO buffer, and a controller for controlling a use of the memory. The controller selects at least one of the data cache, the backup memory and the FIFO buffer to store data received from the data source according to characteristics of the data provided by the data source, and forwards the data stored in the data cache, the backup memory or the FIFO buffer to the electronic device.

### CROSS REFERENCE TO RELATED APPLICATIONS

This application claims the priority of U.S. Provisional Application No. 62/146,420, filed on Apr. 13, 2015, which is included herein by reference in its entirety.

### BACKGROUND

In the network of wearable/mobile/IoT devices, data or services are provided and transmitted over network that consists of multiple different types of links, and each of the devices may have at least one connectivity technology to connect to other device(s) to form a network to access much more data.

However, in the wireless environment, the connections between the devices are relatively unstable, the routs may change continuously, and/or some unconstrained device may be asleep so as to loss connection, and these issues may cause the data transmission between the devices not always being available. In addition, because the data transmission between the devices is not always available, the data may be re-transmitted from the source device, causing overhead to every node on the path and the source device.

### SUMMARY

It is therefore an objective of the present invention to provide a data aggregator serving between a data source and an electronic device, to solve the above-mentioned problems.

According to one embodiment of the present invention, a data aggregator serving between at least one data source and at least one electronic device is provided, wherein the data aggregator is arranged to wirelessly communicate with the data source and the electronic device, and the data aggregator comprises a memory comprising a data cache, a backup memory and a first-in-first-out (FIFO) buffer, and a controller for controlling a use of the memory. The controller selects at least one of the data cache, the backup memory and the FIFO buffer to store data received from the data source according to characteristics of the data provided by the data source, and forwards the data stored in the data cache, the backup memory or the FIFO buffer to the electronic device.

According to another embodiment of the present invention, a data management method comprises: wirelessly connecting to a data source and an electronic device; providing a memory comprising a data cache, a backup memory and a first-in-first-out (FIFO) buffer; selecting at least one of the data cache, the backup memory and the FIFO buffer to store data received from the data source according to characteristics of the data provided by the data source; and forwarding the data stored in the data cache, the backup memory or the FIFO buffer to the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a system according to one embodiment of the present invention.

FIG. 2 is a flowchart of the data management method according to one embodiment of the present invention.

FIGS. 3A, 3B and 3C are diagrams showing the data flow according to a first embodiment of the present invention.

FIGS. 4A, 4B and 4C are diagrams showing the data flow according to a second embodiment of the present invention.

FIG. 5 is a diagram illustrating a system according to another embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

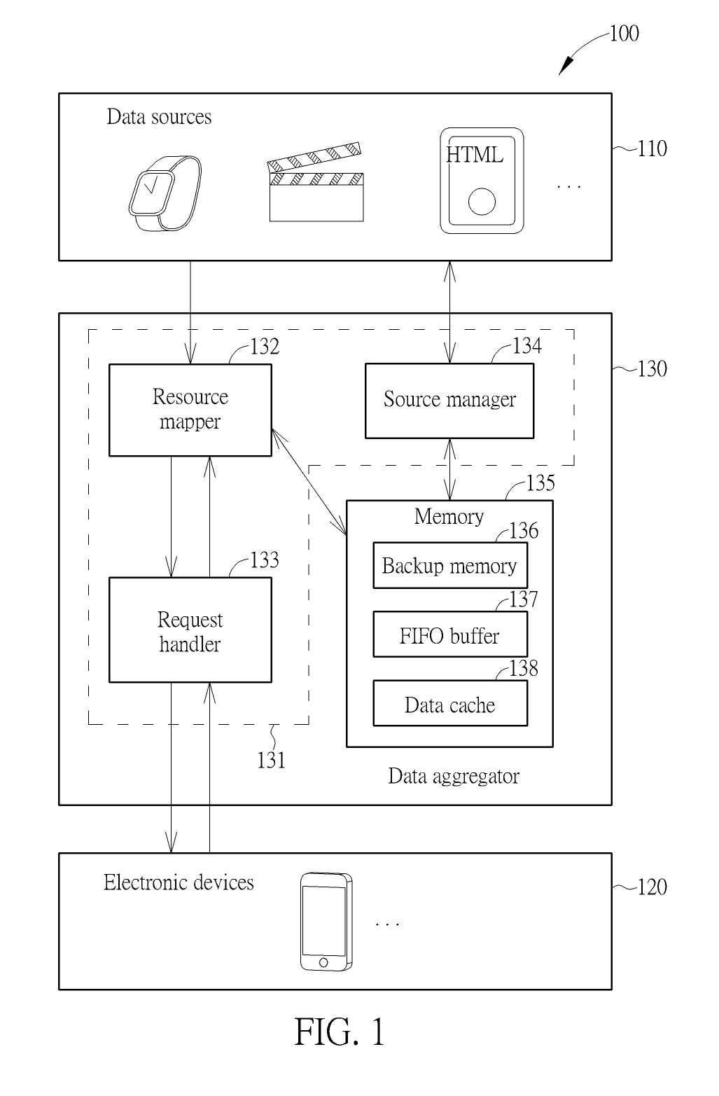

Please refer to FIG. 1, which is a diagram illustrating a system 100 according to one embodiment of the present invention. As shown in FIG. 1, the system 100 comprises at least one data source 110, at least one electronic device 120 and a data aggregator 130. In this embodiment, there are several data sources 110 comprising a smart watch, a device for providing video/audio stream and/or web page, a GPS tracker, a wristband . . . etc., and the electronic device 120 serves as an client to receive the data from the data source 110, and the data aggregator 130 serves as an intermediary between the data source 110 and the electronic device 120. In addition, the data aggregator 130 is arranged to wirelessly communicate with the data source 110 and the electronic device 120.

The data aggregator 130 comprises a controller 131 and a memory 135, where the controller 131 can be implemented by software module or hardware module, and the controller 131 is arranged to control the use of the memory 135, and the controller 131 comprises a resource mapper 132, a request handler 133 and a source manager 134; and the memory 135 comprises a backup memory 136, a first-in-first-out (FIFO) buffer 137 and a data cache 138. In the data aggregator 130, the resource mapper 132 is arranged to map the data source 110 to the memory 135 when the data source 110 registers, provide a resource list to the electronic device 120, and query data from the memory 135. The request handler 133 is arranged to receive and handle the queries from the electronic device 120, for example, the electronic device 120 may send request to query the resource list and/or query data, and the request handler 133 queries the resource mapper 132 to obtain the resource list and/or required data, and sends the resource list and/or required data to the electronic device 120. The source manager 134 is arranged to perform data fetch and/or data synchronization operations, and store the data received from the data source 110 to the memory 135. In the memory 135, the backup memory 136 is used to store data provided by the data source 110, but the stored data may not immediately provide to the electronic 120; the FIFO buffer 137 is arranged to buffer the streams or real-time services transmitted from the data source 110 to the electronic device 120; and the data cache 138 stores data that has sent to the electronic device 120 so future requests for that data can be served faster.

In the operations of the data aggregator 130, the controller 131 may select at least one of the backup memory 136, the FIFO buffer 137 and the data cache 138 to store data received from the data source 110 according to characteristics of the data provided by the data source 110. For example, when the data provided by the data source 110 is static data such as pictures, health history or data of the step counter, or the data source 110 does not have enough storage to store data, or the connection between the data source 110/electronic device 120 and the data aggregator 130 is unstable, the controller 131 may select the backup memory 136 to store the data received from the data source 110, where stable or unstable connection between the data source 110/electronic device 120 and the data aggregator 130 can be determined based on the wireless connection type, signal strength, bit error rate, packet loss rate or any other suitable quality diagnosis method. When the controller 131 selects the backup memory 136 to store the data from the data source 110, the controller automatically synchronizes with the data source 110, and the data received from the data source 110 is with corresponding timestamps to let the electronic device 120 to judge if the data is expired. In addition, the backup memory 136 stores data with cache ability, that is when the backup memory 120 is selected, the data cache 138 is also used to temporarily store the data sent to the electronic device 120.

For the FIFO buffer 137, when the data source 110, such as a camera, provides a video/audio stream or a real-time service, or the data provided by the data source 110 is private data that cannot be cached, the controller 131 may select the FIFO buffer 137, and the data source 110 sequentially and continuously sends the data to the electronic device 120 via the controller 131 and the FIFO buffer 137.

For the data cache 138, when the data provided by the data source 110 is static data, or the data source 110 has its own storage, or the connection between the data source 110/electronic device 120 and the data aggregator 130 is stable, the controller 131 may select the data cache 138 to temporarily store the data from the data source 110 to the electronic device 120.

In the embodiment shown in FIG. 1, the data aggregator 130 can be built in a wireless access point (AP), and AP can wirelessly connect to the data source 110 and the electronic device 120 by using WiFi or related standards. In some examples, the data transmission between the data source 110 and electronic device 120 is performed in local networking (such as LAN, local area network, used for homes, offices, and schools, . . . and so on) rather than connecting to a remote device (such as connecting to a remote cloud server, or connecting to WAN, wide area network, used for cities, states, nations, . . . and so on). In addition, the data aggregator 130 can automatically update the data cache 138, and the data aggregator 130 may proactively search nearby devices with available data sources to collect data. Particularly, in this embodiment, the electronic device 120 does not know the data source 110, and the electronic device 120 merely needs to send the data query to fetch the data from the data aggregator 130, without directly communicating with the data source 110.

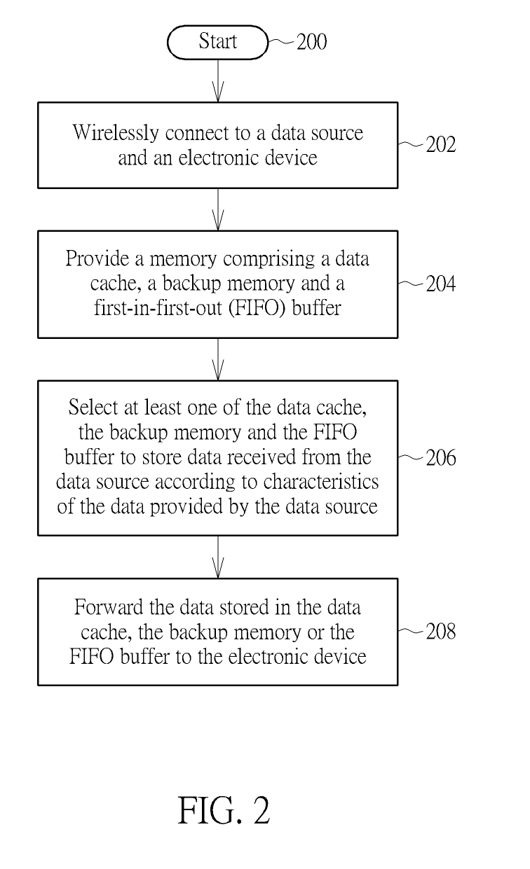

FIG. 2 is a flowchart of the data management method according to one embodiment of the present invention. Refer to FIG. 1 and FIG. 2 and above disclosure, the flow is described as follows.

Step 200: the flow start.

Step 202: wirelessly connect to a data source and an electronic device.

Step 204: provide a memory comprising a data cache, a backup memory and a FIFO buffer.

Step 206: select at least one of the data cache, the backup memory and the FIFO buffer to store data received from the data source according to characteristics of the data provided by the data source.

Step 208: forward the data stored in the data cache, the backup memory or the FIFO buffer to the electronic device.

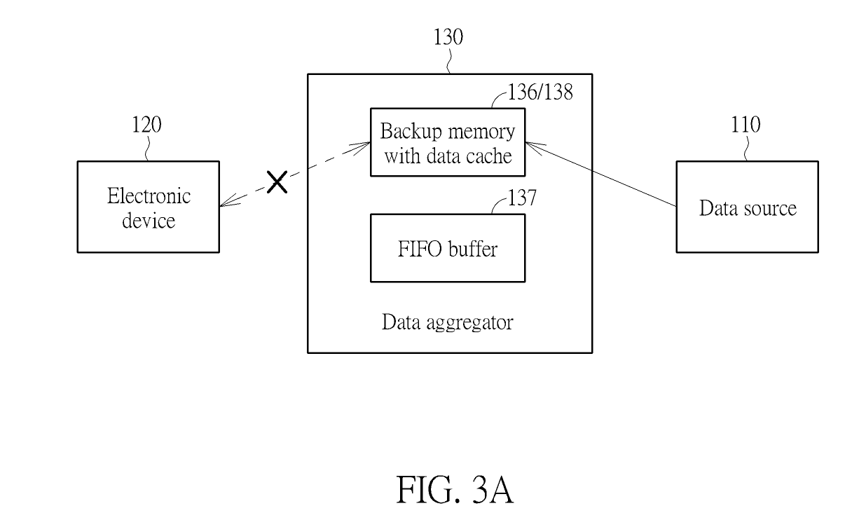

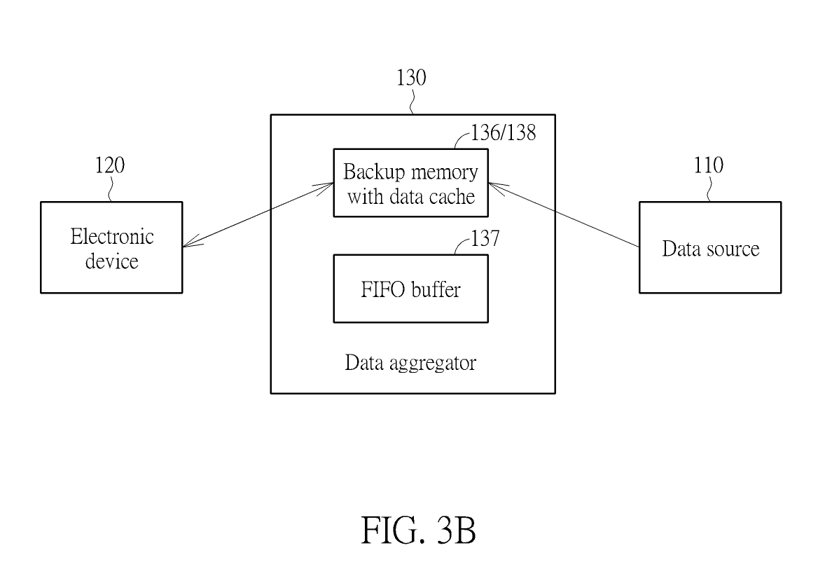

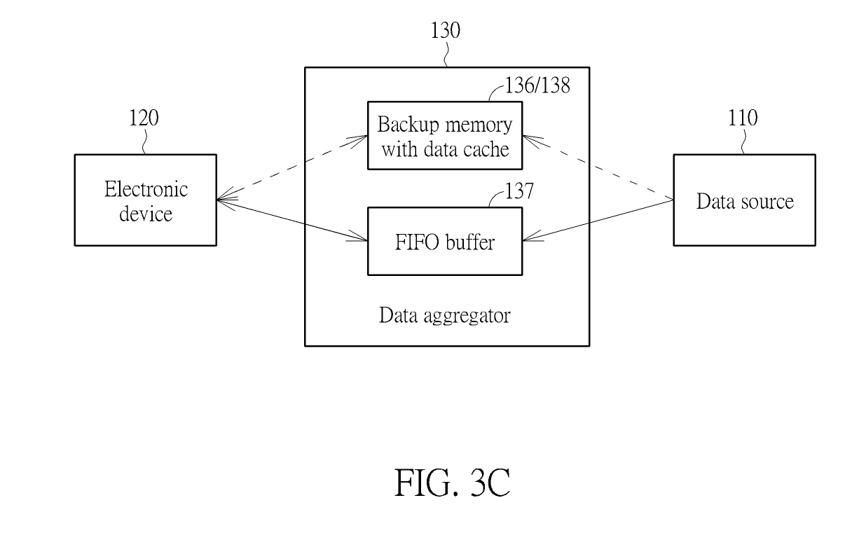

Please refer to FIG. 3A, 3B and 3C, which are diagrams showing the data flow according to a first embodiment of the present invention. In FIG. 3A, the electronic device 120 is out of connection with the data aggregator 130, then the data aggregator 130 still continuously fetches/pre-fetches the data from the data source even if the electronic device 120 is out of connection, and stores the data into the backup memory 136 with the data cache 138. In FIG. 3B, when the electronic device 120 reconnects the data aggregator 130, the electronic device 120 directly fetches the data stored in the backup memory 136 and/or the data cache 138 of the data aggregator 130. In FIG. 3C, if the data aggregator 130 detects that the received data is streaming or real-time service, for shorter latency, the data aggregator 130 can switch to the FIFO buffer 137 to buffer the data from the data source 110 to the electronic device 120, and the data can be cached by the data cache 138 simultaneously or not. In this embodiment, even if the electronic device 120 is out of connection, the data aggregator 130 can still continuously fetch data from the data source 110. Therefore, extra overhead of retransmitting lost data/request (such as the lost data between the data aggregator 130 and the data source 110) due to disconnection can be avoided.

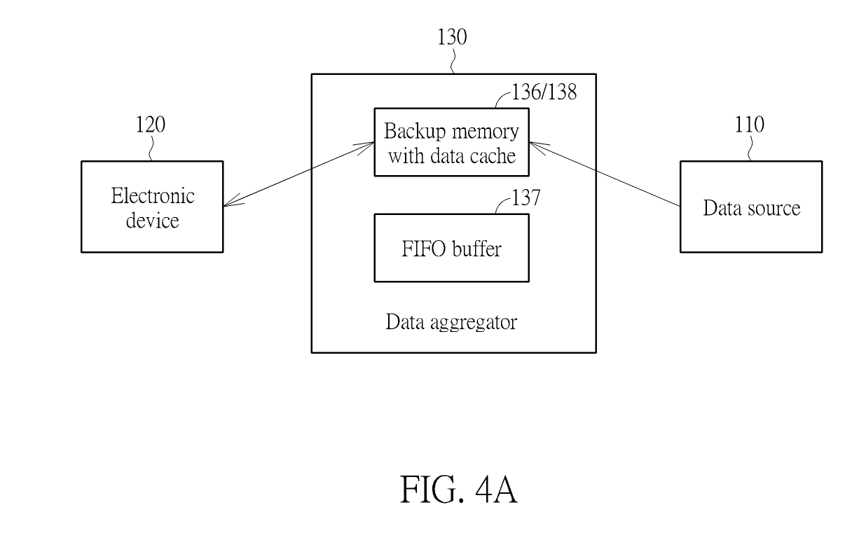

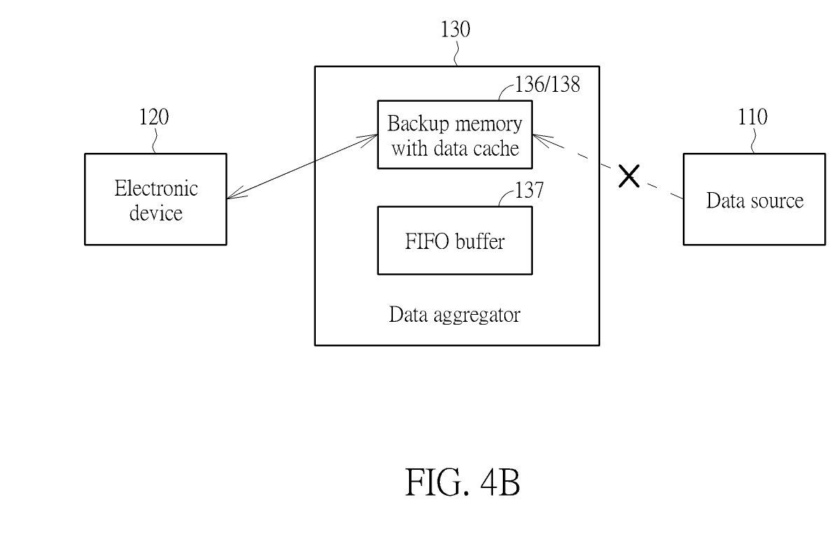

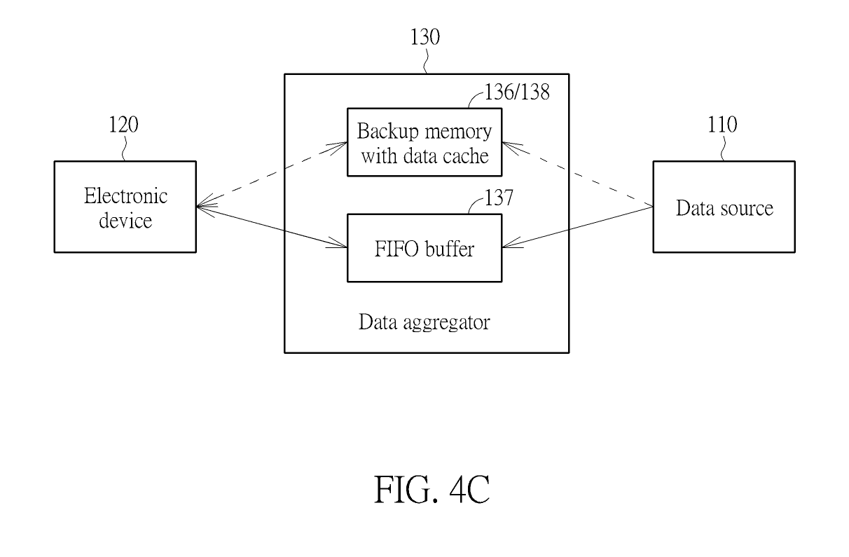

Please refer to FIGS. 4A, 4B and 4C, which are diagrams showing the data flow according to a second embodiment of the present invention. In FIG. 4A, the data aggregator 130 pre-fetches the data from the data source 110, and stores the data into the backup memory 136 with the data cache 138. Meanwhile, the electronic device 120 fetches the data stored in the backup memory 136 and/or data cache 138, where the backup memory 136 still has remaining data not transmitted to the electronic device 120 (e.g. the data transmission rate between the electronic device 120 and the backup memory 136 is slower than the data transmission rate between the backup memory 136 and the data source 110). In FIG. 4B, once the data source 110 is out of connection with the data aggregator 130, the electronic device 120 continuously fetches the remaining data provided by the data source 110 in the backup memory 136 until all the remaining data is fetched. In FIG. 4C, when the data source 110 reconnects the data aggregator 130, the data source 110 can sequentially transmit data to the data aggregator 130. In addition, if the data aggregator 130 detects that the received data is streaming or real-time service, for shorter latency, the data aggregator 130 can switch to the FIFO buffer 137 for buffering the data from the data source 110 to the electronic device 120, and the data can be cached by the data cache 138 simultaneously or not. In this embodiment, even if the data source 110 is out of connection, the data aggregator 130 can still continuously transmit data to the electronic device 120. Therefore, extra overhead of retransmitting lost data/request (such as the lost request between the data aggregator 130 and the electronic device 120) due to disconnection can be avoided.

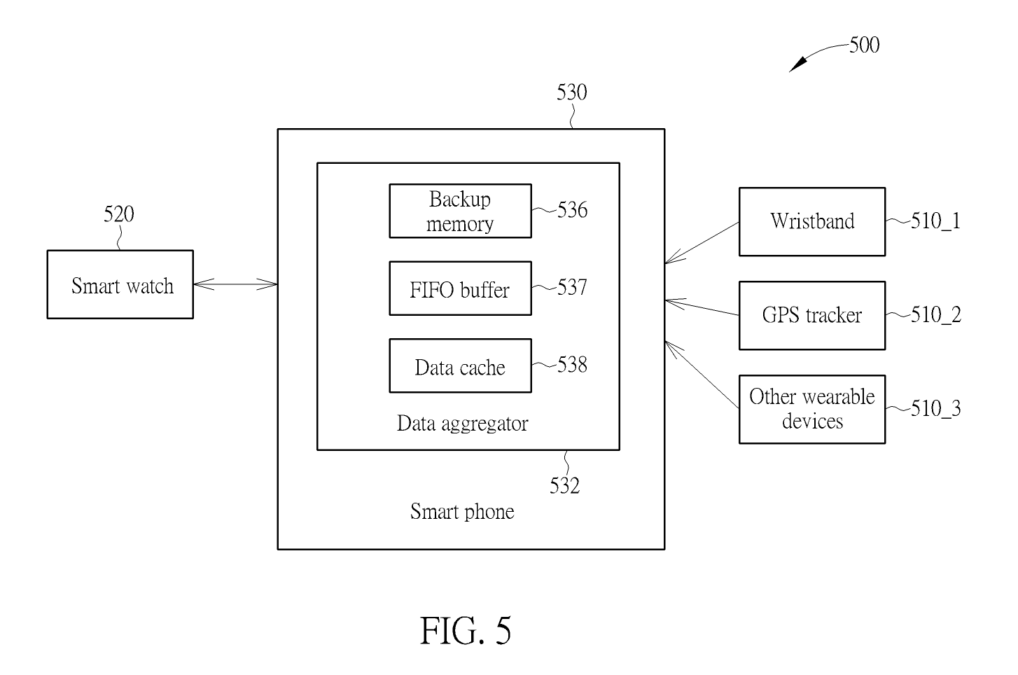

In the above-mentioned embodiments, the electronic device 120 maybe a smart phone or a tablet, and the data aggregator 130 is built in the AP. In other embodiment, however, the data aggregator can be built in the smart phone or a tablet. Referring to FIG. 5, which is a diagram illustrating a system 500 according to another embodiment of the present invention. As shown in FIG. 5, the system 500 comprises a plurality of data sources such as wristband 510_1, GPS tracker 510_2 and other wearable devices 510_3, a smart watch 520 and a smartphone 530 comprising a data aggregator 532, where the data aggregator 532 comprises a backup memory 536, a FIFO buffer 537 and a data cache 538. The operations of the data aggregator 532 are much similar to the operations of the data aggregator 130 as described in FIG. 1, that is the data aggregator 532 can select at least one of the data cache 538, the backup memory 536 and the FIFO buffer 537 to store data received from the wristband 510_1, GPS tracker 510_2 and other wearable devices 510_3 according to characteristics of the data provided by these data sources, and send the stored data to the smart watch 520. Because the operations of the data aggregator have described in the above embodiments, further descriptions are omitted here.

Briefly summarized but not limited, in the data aggregator and associated data management method of the present invention, the data aggregator serves between the data source and the electronic device, and the data aggregator has a backup memory to store the data from the data source. Therefore, even if the electronic device is out of connection, the data aggregator can continuously fetch data from the data source to avoid extra overhead of redundant data transmission of the data source; and even if the data source is out of connection in a short time, the electronic device still can fetch the remaining data from the data aggregator.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data aggregator serving between at least one data source and at least one electronic device, wherein the data aggregator is arranged to wirelessly communicate with the data source and the electronic device, and the data aggregator comprises:
a memory, comprising a data cache, a backup memory and a first-in-first-out (FIFO) buffer; and
a controller, for controlling the memory;
wherein the controller selects at least one of the data cache, the backup memory and the FIFO buffer to store data received from the data source according to characteristics of the data provided by the data source.

2. The data aggregator of claim 1, wherein the controller selects the backup memory to store the data received from the data source, the controller automatically synchronizes with the data source, and the data received from the data source is with corresponding timestamps.

3. The data aggregator of claim 1, wherein when the controller selects the backup memory to store the data received from the data source, the backup memory continuously receives and stores the data received from the data source even if the electronic device is out of connection with the data aggregator or the electronic device does not fetch the data of the data source.

4. The data aggregator of claim 1, wherein when the electronic device is out of connection with the data aggregator, the controller selects the backup memory to store the data received from the data source.

5. The data aggregator of claim 1, wherein when the data provided by the data source is static data, the controller selects the backup memory to store the data received from the data source.

6. The data aggregator of claim 1, wherein when a connection between the data source and the data aggregator or a connection between the data source and the data aggregator is unstable, the controller selects the backup memory to store the data received from the data source.

7. The data aggregator of claim 1, wherein when the electronic device is out of connection with the data aggregator, the controller pre-fetches the data from the data source and stores the data into the backup memory; and when the electronic device reconnects the data aggregator, the electronic device fetches the data stored in the backup memory of the data aggregator.

8. The data aggregator of claim 1, wherein the controller pre-fetches the data from the data source and stores the data into the backup memory, and the electronic device fetches the data stored in the backup memory; and when the data source is out of connection with the data aggregator, the electronic device continuously fetches the remaining data provided by the data source in the backup memory until all the remaining data is fetched.

9. The data aggregator of claim 1, wherein the data aggregator is built in a wireless access point.

10. The data aggregator of claim 1, wherein the data aggregator is built in a smart phone or a tablet.

11. A data management method, comprising:
wirelessly connecting to a data source and an electronic device;
providing a memory comprising a data cache, a backup memory and a first-in-first-out (FIFO) buffer;
selecting at least one of the data cache, the backup memory and the FIFO buffer to store data received from the data source according to characteristics of the data provided by the data source; and
forwarding the data stored in the data cache, the backup memory or the FIFO buffer to the electronic device.

12. The data management method of claim 11, further comprising:
when the backup memory is selected to store the data received from the data source, automatically synchronizing with the data source, and receiving the data from the data source with corresponding timestamps.

13. The data management method of claim 11, further comprising:
when the backup memory is selected to store the data received from the data source, the backup memory continuously receives and stores the data received from the data source even if the electronic device is out of connection or the electronic device does not fetch the data of the data source.

14. The data management method of claim 11, wherein the step of selecting at least one of the data cache, the backup memory and the FIFO buffer to store data received from the data source according to characteristics of the data provided by the data source comprises:
when the electronic device is out of connection, selecting the backup memory to store the data received from the data source.

15. The data management method of claim 11, wherein the step of selecting at least one of the data cache, the backup memory and the FIFO buffer to store data received from the data source according to characteristics of the data provided by the data source comprises:
when the data provided by the data source is static data, selecting the backup memory to store the data received from the data source.

16. The data management method of claim 11, wherein the step of selecting at least one of the data cache, the backup memory and the FIFO buffer to store data received from the data source according to characteristics of the data provided by the data source comprises:
when a connection between the data source and the data aggregator or a connection between the data source and the data aggregator is unstable, selecting the backup memory to store the data received from the data source.

17. The data management method of claim 11, wherein when the electronic device is out of connection with the data aggregator, the controller pre-fetches the data from the data source and stores the data into the backup memory; and when the electronic device reconnects the data aggregator, the electronic device fetches the data stored in the backup memory of the data aggregator.

18. The data management method of claim 11, wherein the controller pre-fetches the data from the data source and stores the data into the backup memory, and the electronic device fetches the data stored in the backup memory; and when the data source is out of connection with the data aggregator, the electronic device continuously fetches the remaining data provided by the data source in the backup memory until all the remaining data is fetched.

19. The data management method of claim 11, wherein data management method is executed by a data aggregator built in a wireless access point.

20. The data management method of claim 11, wherein data management method is executed by a data aggregator built in a smart phone or a tablet.
